(19) United States
(12) Patent Application Publication
(10) Pub. No.: US 2008/0272742 A1
(43) Pub. Date: Nov. 6, 2008

(54) Method and apparatus for acquiring battery temperature measurements using stereographic or single sensor thermal imaging

(76) Inventors: William Stephen Hart, Plano, TX (US); Brian L. Graham, Carrollton, TX (US); John Arthur Fee, Garland, TX (US)

Correspondence Address: JACKSON WALKER LLP, 901 MAIN STREET, SUITE 6000, DALLAS, TX, 75202-3797, US

(21) Appl. No.: 12/150,804

(22) Filed: May 1, 2008

Related U.S. Application Data
(60) Provisional application No. 60/927,055, filed on May 1, 2007.

(51) Int. Cl. H02J 7/00

(52) U.S. Cl. 320/150

(57) ABSTRACT

A method and apparatus for acquiring battery temperature measurements using stereographic thermal imaging sensors or a simple single thermal imaging sensor which can detect increases in battery heat within the field of view of any single thermal sensor, or any combination of a plurality of thermal imaging sensors is presented. Infrared Detection (ID) using the thermal imaging sensor (pyrometer) is used to focus on certain parts of a housing thereby providing an ability to “see through” or “partially see through” the battery housing to battery cells enclosed by the battery housing. Advantageously, this affords the unique capability of measuring the battery temperature before heat propagates from an individual battery cell or a plurality of battery cells to the battery housing, allowing faster heat gradient detection. Moreover, universality of battery temperature monitoring is achieved by elimination of proprietary communication between the manufacturer of the battery and the charger.

### CLAIM OF PRIORITY

This application claims priority of U.S. Provisional Ser. No. 60/927,055 entitled METHOD AND APPARATUS FOR ACQUIRING BATTERY TEMPERATURE MEASUREMENTS USING STEREOGRAPHIC OR SINGLE SENSOR THERMAL IMAGING, filed May 1, 2007, the teachings of which are incorporated herein by reference.

This application is a Continuation-in-Part of U.S. patent application Ser. No. 11/728,462, entitled “METHOD AND APPARATUS FOR A REMOTE BATTERY CHARGER WITH A SELF-CONTAINED POWER SOURCE,” filed Mar. 26, 2007, and is also a Continuation-in-Part of U.S. patent application Ser. No. (TBD), entitled “METHOD AND APPARATUS TO PROVIDE FIXED FREQUENCY CHARGING SIGNALS TO A BATTERY AT OR NEAR RESONANCE,” filed Apr. 21, 2008 (Our Docket: 126595.00034), the teachings of which are incorporated herein by reference.

### FIELD OF THE INVENTION

The present invention is generally related to temperature detecting devices, and more specifically to battery temperature detecting, thermal imaging devices.

### BACKGROUND OF THE INVENTION

When charging batteries, especially at high rates of recharge current, it is highly desirable to understand and monitor the thermal performance of the battery cells and or packs during the charge cycle. The reasons for this are well documented and understood by those skilled in the art of cell manufacture and battery charging, and are primarily used as a safety mechanism to prevent the cells or packs from venting or bursting. In battery chargers, temperature measurements are typically recorded using thermocouples and/or thermistors which are contained within the manufacturers battery pack. One significant drawback is that these measurement methods are not compatible between different manufacturers of battery cells and packs. For example, some manufacturers use thermistors with different initial values or calibration curves than others. Additionally, manufacturers place Thermocouples or thermistors in different battery locations which may not properly detect and diagnose battery thermal runaway. Even if these devices are placed in a strategic location, a battery cell may overheat in a location away from the thermistor thereby destroying the battery pack or cell. Further, many battery pack manufacturers do not use thermal measurement devices at all. The myriad of battery pack manufacturers, each with proprietary thermal measurement techniques, make it nearly impossible to make a universal charger which employs thermal sensing based upon the manufacturers thermal sensor in the battery.

Battery charging industry consumers need to be protected from potentially dangerous conditions such as over charging or overheating of the battery to the point of leaking dangerous substances or exploding. In the past, there have been a few proprietary safety mechanisms implemented in battery chargers, leaving consumers restricted to batteries made by the same manufacturer of the battery charger.

Currently, most battery manufacturers install thermistors inside a battery case that measure the battery temperature and communicate the battery temperature with the charger. If a certain temperature or change in temperature is exceeded, the charging signal will be terminated. Some existing thermal schemes read case temperature or have sensors placed on a metal bus bar, which yield longer thermal propagation lag times, lasting even minutes, from the battery to the measurement device. This leads to an increased heating of battery cells, and ultimately, a shortened battery lifetime. Therefore, there is desired a contactless battery pack temperature measurement capability. By utilizing thermal imaging devices which can read battery or cell temperature without being in contact with the battery or cell, a method and apparatus is described that can affect battery charging parameters while protecting both the battery and consumers in a reliable way regardless of the battery manufacturer.

### SUMMARY OF THE INVENTION

The present invention achieves technical advantages as a method and apparatus for acquiring battery temperature measurements using stereographic thermal imaging sensors or a simple single thermal imaging sensor which can detect increases in battery heat within the field of view of any single thermal sensor, or any combination of a plurality of thermal imaging sensors. One embodiment of the invention utilizes Infrared Detection (ID) using the thermal imaging sensor (pyrometer) which is focused on certain parts of housing, thereby providing an ability to “see through” or “partially see through” the battery housing to battery cells enclosed by the battery housing. Advantageously, this affords the unique capability of measuring the battery temperature before heat propagates from an individual battery cell or a plurality of battery cells to the battery housing, allowing faster heat gradient detection. Moreover, universality of battery temperature monitoring is achieved by elimination of proprietary communication between the manufacturer of the battery and the charger.

### BRIEF DESCRIPTION OF THE DRAWINGS

FIG. 1 is a diagram of a thermal imaging device disposed in a battery charger in accordance with an exemplary embodiment of the present invention;

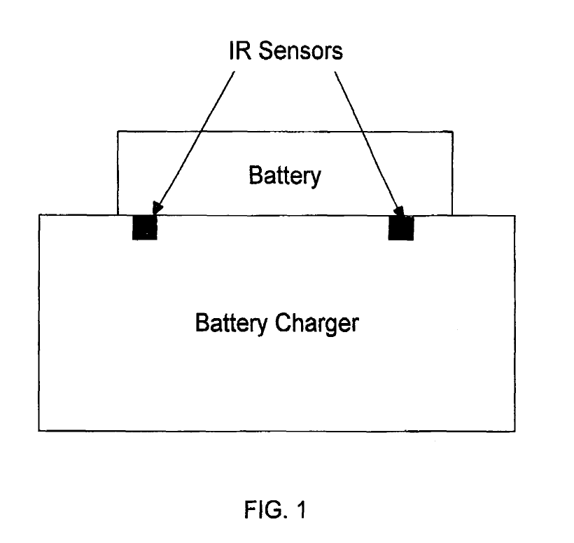

FIG. 2 is a diagram of a thermal imaging device disposed in a battery adapter in accordance with an exemplary embodiment of the present invention;

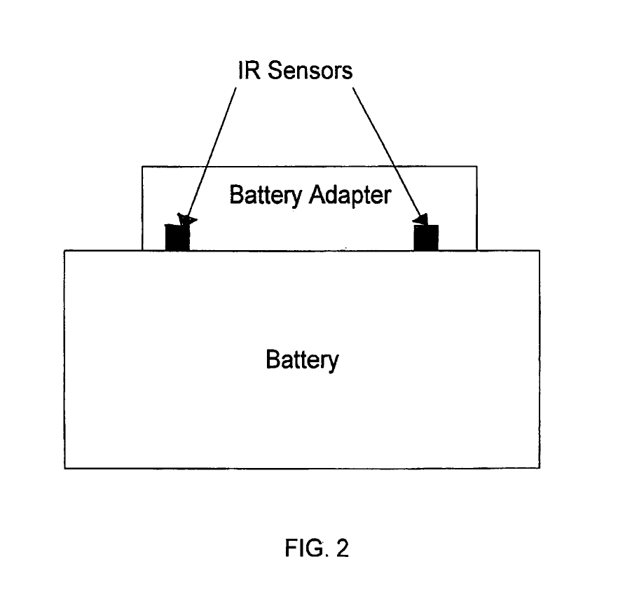

FIG. 3 is a diagram of a thermal imaging device disposed in a battery in accordance with an exemplary embodiment of the present invention; and

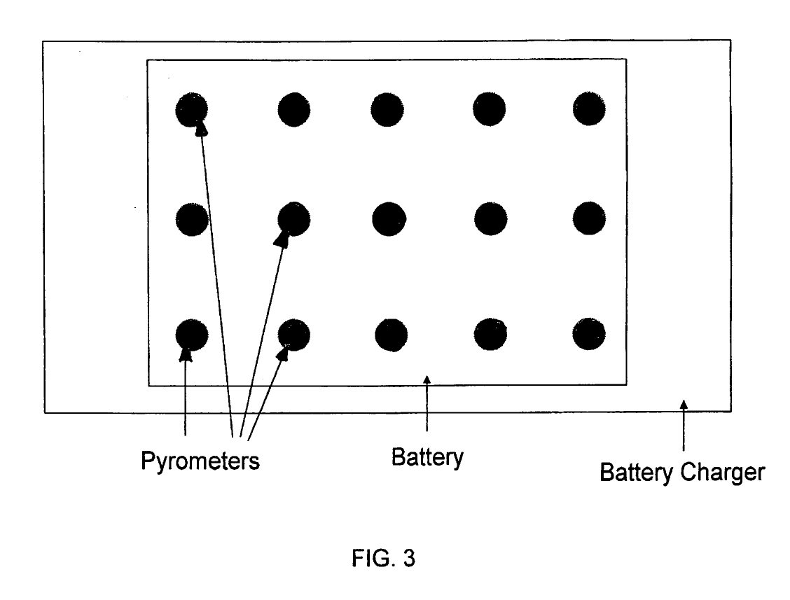

FIG. 4 is a diagram of a thermal imaging device disposed external to the battery and pointed at the battery in accordance with an exemplary embodiment of the present invention.

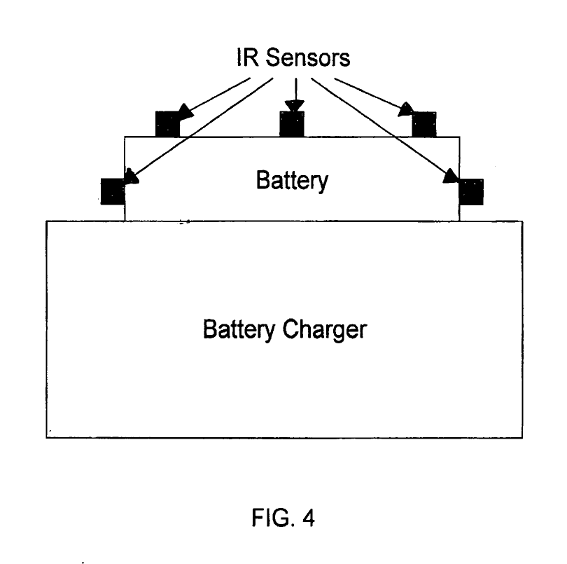

### DETAILED DESCRIPTION OF THE PRESENT INVENTION

Implementation of the present invention can be achieved using at least one of the following techniques: multi-device graphical thermal imaging, stereographic thermal imaging, or single thermal imaging. The stereographic thermal imaging technique aggregates temperature readings and gradients from a plurality of thermal imaging sensors placed proximate a battery pack to obtain an average temperature. “Hot spots” in the battery are identified by comparing the rate of change of temperature with respect to time values sampled from the plurality of sensors. Then, the temperature gradient across the battery pack is calculated, which can aid in early indication of temperature overage or too rapid temperature increases, by identifying areas of the battery which heat up more quickly. The stereographic imaging technique can also track thermal changes during battery charging across the battery. In addition, the thermal imaging device can be used to measure absolute battery pack temperatures (within the tolerances of the imaging devices) which can yield safety improvements such as too hot or too cold batteries. In addition thermal images can be used to measure change in temperature such as deltaT or (Tmax−Tmin) and if the absolute change in battery temperature exceeds a certain value, the charging could be stopped.

Similarly, the single thermal imaging technique samples a temperature reading from a single thermal imaging sensor placed proximate the battery pack. Then, the temperature gradient across the battery pack is calculated by identifying areas of the battery which heat up more quickly. The single thermal imaging technique can also track thermal changes during battery charging across the battery as well as additional parameters as discussed above.

Using the aforementioned measurements, charging parameters can be affected. The change in temperature slope is directly related to charging rates. One exemplary embodiment would limit the charge current at or before the battery temperature slope surpasses a specified limit, thereby avoiding overheating and consequently extending battery life. Additional embodiments can limit charge current during the charging cycle to reduce the thermal inertia of the battery.

A second exemplary embodiment sets a maximum temperature (Tmax) as a safety precaution, helping to greatly reduce the chances of charger malfunction. A third exemplary embodiment uses Tmax to trigger charge termination once Tmax is reached (this is required to ensure that the absolute battery temperature is not exceeded). In a fourth exemplary embodiment, a temperature profile of the battery as it is being charged is correlated with a “typical” charging curves for aging analysis. In a fifth exemplary embodiment, the thermal signature is used to detect battery chemistry.

In a sixth exemplary embodiment, the thermal imaging sensor or sensors are surface mounted on the charger and can be aimed at the battery terminals, at the battery pack at such points as where the battery connectors are soldered inside the battery pack, at the neck of the battery, at the entire battery pack, or any other location which could be used to analyze and detect battery failures, gradients, or gather pertinent data.

In an seventh exemplary embodiment, the thermal imaging sensor is disposed in a universal battery adapter and adapted to connect a plurality of batteries to the charger. The universal battery adapter would house the thermal imaging sensor which would transfer data to the charger to monitor, control, or log data. The use of thermal imaging would allow recording of battery thermal profiles during all uses including charging and discharging. Continual thermal monitoring can be used to assist in the calculation of the battery's state of health (SOH) and display it and other pertinent parameters to consumers. The thermal profile of the entire battery can be monitored to more accurately predict and infer the battery's state of charge (SOC). In an eighth exemplary embodiment, the thermal imaging sensor is disposed in a plurality of battery adapters and adapted to connect a plurality of batteries to the charger.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A battery charger, comprising:
a module having electrical contacts configured to deliver energy to a battery;
charging circuitry configured to deliver the energy to the electrical contacts and charge the battery; and
at least one infrared sensor configured to sense a temperature of a portion of the battery and generate a signal indicative of the temperature, the charging circuitry charging the battery as a function of the signal.

2. The battery charger as specified in claim 1 wherein the signal is indicative of a rate of change of the temperature.

3. The battery charger as specified in claim 1 wherein the signal is indicative of a temperature gradient of the battery.

4. The battery charger as specified in claim 1 wherein the signal is indicative of an absolute temperature of the battery.

5. The battery charger as specified in claim 1 wherein the charging circuitry is configured to compare the signal to a stored parameter, and dynamically deliver the energy as a function of the signal in relation to the parameter.

6. The battery charger as specified in claim 5 wherein the parameter is a maximum temperature.

7. The battery charger as specified in claim 5 wherein the parameter is correlated to a charging curve.

8. The battery charger as specified in claim 7 wherein the charging curve is a function of a type of the battery.

9. The battery charger as specified in claim 7 wherein the parameter is correlated to a state of charge (SOC) curve.

10. The battery charger as specified in claim 5 wherein the charging circuitry is configured to reduce or cease the energy delivered to the battery as a function of the signal in relation to the parameter.

11. The battery charger as specified in claim 1 wherein the sensor is disposed proximate the battery when coupled to the charger.

12. The battery charger as specified in claim 11 wherein the charger includes a recess configured to receive the battery, and the sensor is disposed proximate the recess.

13. The battery charger as specified in claim 12 wherein the sensor is disposed in the recess.

14. The battery charger as specified in claim 11 further comprising an adaptor configured to be disposed in the recess and receive the battery, the sensor being disposed on the adapter.

15. The battery charger as specified in claim 11 further comprising a plurality of the infrared sensors each configured to create a respective said signal.

16. The battery charger as specified in claim 15 wherein the charging circuitry is configured to receive each said sensor signal and charge the battery as a function of the sensor signals.

17. The battery charger as specified in claim 16 wherein the plurality of sensors are configured to sense different portions of the battery to create stereographic imaging of the battery.

18. The battery charger as specified in claim 1 wherein the sensor is configured to generate the signal as a function of an internal portion of the battery.

19. A method of charging a battery, comprising the steps of:
sensing a portion of a battery using at least one infrared detector generating a signal; and
charging the battery as a function of the signal.

20. The method as specified in claim 19 further comprising the step of charging the battery using a charger having an adapter configured to receive the battery, the infrared detector being disposed on the adaptor.
